(19) United States
(12) Patent Application Publication
(10) Pub. No.: US 2004/0260866 A1
(43) Pub. Date: Dec. 23, 2004

(54) Method and apparatus for minimizing instruction overhead

(76) Inventor: Andrew P. Davis, Santa Cruz, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/190,070

(22) Filed: Jul. 3, 2002

(51) Int. Cl. G06F 12/00

(52) U.S. Cl. 711/108; 711/104

(57) ABSTRACT

For one embodiment, a rule engine is configured to perform data matching and, through the use of padding information, normalizes the layout of data being supplied directly to processor storage elements. The rule engine comprises a content addressable memory (CAM), a random access memory (RAM) and at least one controller coupled to the RAM and the CAM. Based on the operations by the RAM and CAM, the controller creates a substantially uniform layout, which is shared by multiple data sets including an incoming data set associated with the data.

### FIELD

Embodiments of the invention generally relate to the field of data processing. More particularly, the invention relates to a method and apparatus for minimising the amount of load, store and contexting instructions needed by a processor to process multiple data set formats.

### GENERAL BACKGROUND

most generic data processing code associated with a Reduced Instruction Set Computer (RISC) process architecture features multiple stages of operation. A first stage of operation involves the parsing of an incoming data set. Herein, a “data set” is generally considered to as a grouping of bits, which may be segregated into fields. During the parsing operation, the context of the data set is established by which the format of the data set and its intended destination are determined. In addition, a sequence of LOAD/STORE instructions are executed by the RISC processor to coordinate retrieval and temporary storage of data within the data set in on-chip processor registers as well as the return of such data.

Currently, a STORE operation writes data from processor registers into off-chip memory. In contrast, a LOAD instruction, when executed, normally retrieves data from some off-chip bulk memory for temporary storage in processor registers. Prior to such storage, however, the layout of the data set is computed before the data is retrieved from the off-chip bulk memory. Similarly, the data set may be stored in on-chip memory in close proximity to the processor prior to determining the layout for loading into the processor registers and retrieving the data.

It is evident that none of these system configurations, however, has any involvement in the contexting or arranging of the layout of the data within the processor registers.

For RISC processors designed to support multiple types of data sets, conventional parsing operations pose a number of disadvantages. For instance, multiple versions of instruction code are needed in order to process multiple data set formats. This leads to a greater amount of required memory, higher costs and greater system complexity.

Also, by loading data into memory in lieu of loading the data into the processor registers directly, the overall operational speed of the device employing the processor is adversely effected.

### SUMMARY

One embodiment of the invention relates to an apparatus and method for minimizing the amount of load, store and contenting instructions needed by a processor in processing data sets with different formats. This apparatus involves a Rule Engine operating in combination with processor registers. Upon receiving a data set, the Rule Engine parses the data set into a common format shared by multiple data sets. This data is loaded directly into the processor registers.

### BRIEF DESCRIPTION OF THE DRAWINGS

The features and advantages of embodiments of the invention will become apparent from the following detailed description of the invention in which:

FIG. 1 is an exemplary embodiment of a communication system utilizing the invention.

FIG. 2 is an exemplary embodiment of a computing unit of FIG. 1.

FIG. 3 is an exemplary embodiment of a Rule Engine implemented within a processor of the computing unit of FIG. 2.

FIG. 4 is an exemplary embodiment of processing rules grouped into stages and being followed by the Rule Engine of FIG. 3.

FIG. 5 is an illustrative embodiment of the operations of the Rule Engine of FIG. 3.

FIG. 6 is an illustrative embodiment of a flowchart describing padding operations of the Rule Engine of FIG. 3.

### DETAILED DESCRIPTION

In general, one embodiment of the invention relates to a an apparatus and method for minimizing the amount of load, store and contexting instructions needed by a processor in processing data sets with different formats. This is accomplished through the development of a rule engine that performs string matching and, through the use of data padding, normalizes the layout of data being supplied directly to processor storage elements. In summary, the data within the data set is parsed by the rule engine into a common layout, shared by most of the data set types supported by the processor, before such data is loaded directly into the processor storage elements.

Certain details are set forth below in order to provide a thorough understanding of the invention, albeit the invention may be practiced through many embodiments other that those illustrated. Well-known logic and operations are not set forth in detail in order to avoid unnecessarily obscuring the invention.

In the following description, certain terminology is used to describe certain features of the invention. For example, a “data set” is a grouping of bits arranged in a determined format. For example, one type of data set is a packetized frame such as a Media Access Control (MAC) frame. The MAC frame may have a number of different formats such as having a MAC header with a virtual local area network identifier (VLAN ID) or one without a VLAN ID. A “field” is a grouping of bits within the data set. A “storage element” is defined as an area for data storage such as one or more cells of either volatile or non-volatile memory, one or more registers and the like.

A “computing unit” is a device that is adapted with a processor to process data within a data set. The processor may receive a data set from an internal source (e.g., configuration information stored in BIOS) or from an external source (e.g., via a communication port). Typically, the computing unit may be employed as a computer (e.g., server, desktop, laptop, hand-held, mainframe, or workstation), a set-top box, a network switch(e.g., router, bridge, switch, etc.) or any electronic products featuring a processor.

A “processor” includes logic, namely hardware, software or a combination thereof. Herein, the processor comprises circuitry under control by one or more software modules. A “software module” is a series of instructions that, when executed, performs a certain function. Examples of a software module include a Basic Input/Output System (BIOS), an operating system (OS), an application, an applet, a program or even a routine. One or more software modules may be stored in a machine-readable medium, which includes but is not limited to an electronic circuit, a semiconductor memory device, a read only memory (ROM), a flash memory, a type of erasable programmable ROM (EPROM or EEPROM), a floppy diskette, a compact disk, an optical disk, a hard disk, or the like.

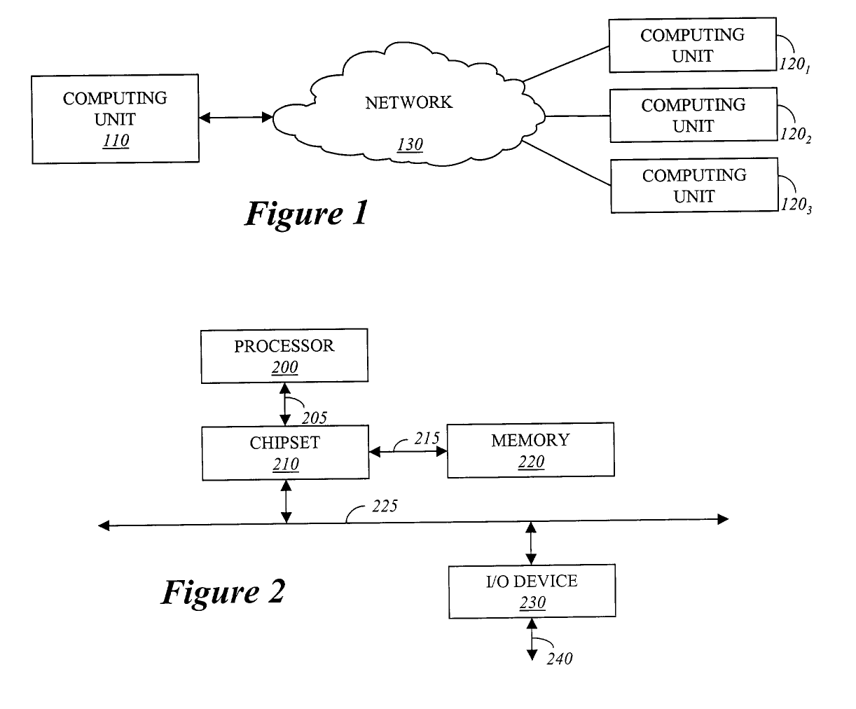

Referring to FIG. 1, an exemplary embodiment of a communication system 100 is shown. Herein, the system 100 comprises a computing unit 110 in communication with other computing units 120₁-120_{N} over a network 130, where “N” is greater than one but equal to three for this embodiment. As shown, the network 130 may be any type of network such as a wide area network (WAN) or a local area network (LAN) . Of course, computing unit 110 need not be implemented within a network but may be a dedicated, stand-alone device.

Referring now to FIG. 2, an exemplary embodiment of computing unit 110 of FIG. 1 is shown. For this embodiment, computing unit 110 comprises a processor 200, a memory 220 and an input/output (I/O) device 230. In one embodiment, processor 200 represents a central processing unit of any type of architecture, such as complex instruction set computers (CISC), reduced instruction set computers (RISC), very long instruction word (VLIW), or a hybrid architecture. Of course, processor 200 may be implemented as multiple processing units coupled together over a common host bus 205.

In this embodiment, as shown, processor 200 is a Reduced Instruction Set Computer (RISC) processor that utilizes LOAD and STORE instructions for inputting data into and extract data from processor storage elements (e.g., on-chip processor registers). In other embodiments, however, processor 200 may any configured as any logic capable of processing data such as, for example, a microprocessor, digital signal processor, application specific integrated circuit (ASIC), or microcontroller.

Coupled to processor 200 via host bus 205, a chipset 210 may be integrated to provide control and configuration of system memory 220 and at least one I/O device 230 over links 215 and 225. The system memory 220 stores system code and data. The system memory 220 is typically implemented with dynamic random access memory (DRAM) or static random access memory (SRAM).

The I/O device 230 is coupled to chipset 210 via a link 225 such as a Peripheral Component Interconnect (PCI) bus at any selected frequency (e.g., 66 megahertz “MHz”, 100 MHz, etc.), an Industry Standard Architecture (ISA) bus, a Universal Serial Bus (USB) or another bus configured with a different architecture than those briefly mentioned. I/O device 230 is adapted to support communications with a device external to the computing unit via link 240, including receiving a data set for routing to processor 200. A “link” is an information-carrying medium such as electrical wire(s), optical fiber(s), cable, bus(es), or air in combination with wireless signaling technology.

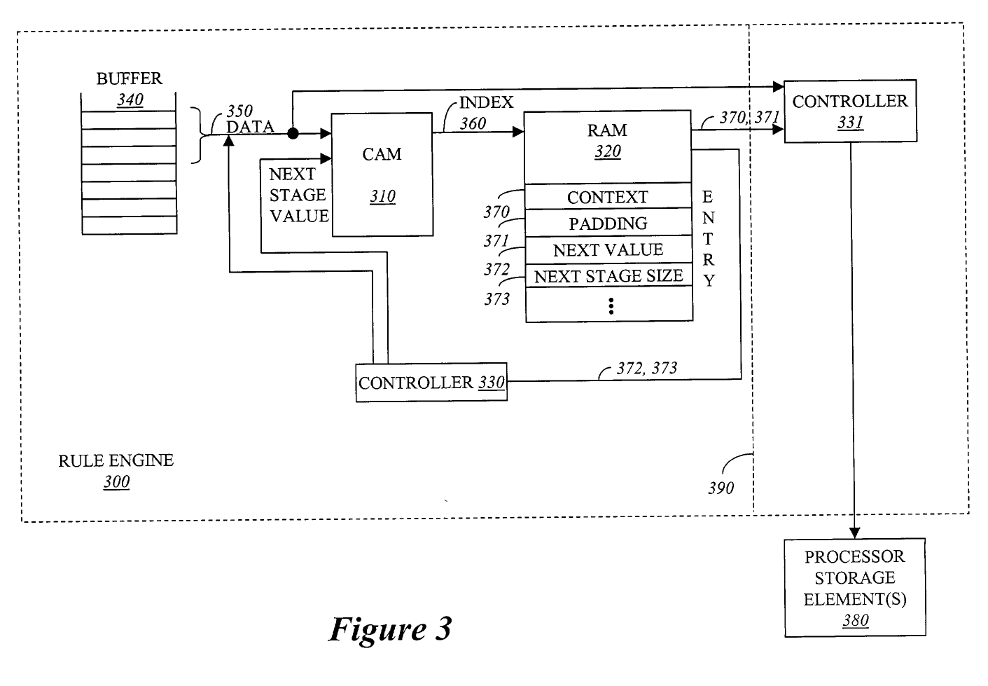

Referring to FIG. 3, an exemplary embodiment of a Rule Engine 300 implemented within the processor 200 of computing unit 110 of FIG. 2 is shown. The Rule Engine 300 is in communications with one or more processor storage elements. For this embodiment, the Rule Engine 300 operates as a string matching engine with programmable comparisons, which parses the incoming data set to establish a context for the data (e.g., type of data set, format, etc.) and develop a substantially uniform layout for that data by using padding where appropriate. As a result, the layout can support many different frame types.

For this embodiment of the invention, the Rule Engine 300 comprises a content addressable memory (CAM) 310, a random access memory (RAM) 320 and at least one controller 330. Normally, a first controller 330 is configured to access data from a buffer 340, which is used to temporarily store data within an incoming data set. The amount of data initially accessed may be arbitrary or may be based on processing rules pre-programmed within the Rule Engine 300.

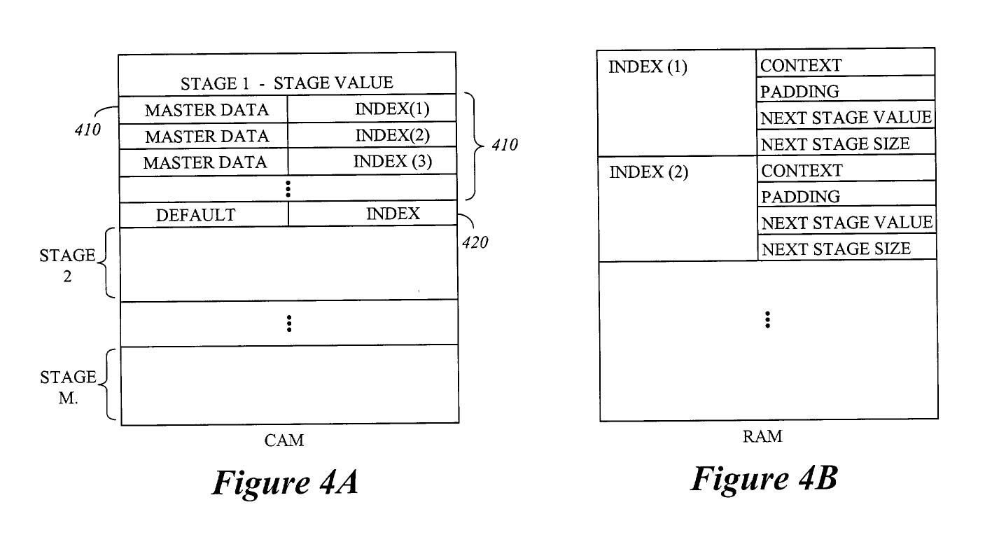

As shown in FIG. 4A, with respect to the rules associated with CAM 310, these processing rules are grouped into M stages 400₁-400_{M} (M≧1). Each stage 400_{M} includes one or more rules 410 and a default rule 420. As shown, the rules may be represented as data to be matched (referred to as “master data”) along with an index, which is output when a match occurs. The default rule 420 is applied when none of the rule(s) 410 in the stage is matched.

As shown in FIG. 4B, with respect to the rules associated with RAM 320, these processing rules are grouped as P indices 420₁-420_{P} (P≧1). As shown, each index 420₁, . . . , 420_{P} is associated with state information, including but not limited or restricted to the following: content information, padding, next stage value and next stage size (in some unit of measure) as described below.

Referring back to FIG. 3, the accessed data 350 is routed to CAM 310, which compares such data 350 to master data pre-loaded into CAM 310. Such comparison is based on data processing rules associated with the current stage at which the Rule Engine 300 is operating. The master data may be any size such as “U” bytes of data (U being a positive integer, U≧1), “V” bits of data (V being a positive integer, V≧1) and the like.

Upon determining a match, CAM 310 outputs an index 360 to RAM 320. The index 360 is used to select an entry within RAM 320. The contents of this entry provide pre-loaded information used to configure a layout for loading data into processor storage element(s) 380.

As shown, for this embodiment of the invention, RAM 320 provides context information 370 and padding 371, namely set values (operating as blank spaces) placed before or after bits/bytes associated with the accessed data 350, to a second controller 331. These values may be assigned a predetermined value such as zero. The second controller 331 further receives data as it is extracted from buffer 340. Based on this information, second controller 331 controls the layout of data so as to normalize the layout of data being supplied directly to processor storage element(s) 380.

Also, as feedback, RAM 320 provides a next stage value 372 and a size (in units) of the next field to be matched (referred to as “next field size” 373) to first controller 330. The next stage value 372 indicates the next stage of data processing rules to be followed. For instance, if fifteen stages of processing rules are supported, the stages may be assigned values 0-14 with the first stage assigned “0” and the last stage assigned “14”. Successive next stage values do not need to be in numerical order because different stages may be skipped depending on the content of the matched data.

Based on the feedback information, first controller 330 is able to extract a desired amount of data from buffer 340 and provide both next stage value and the newly accessed data to CAM 310. This interaction between CAM 310, RAM 320 and controller(s) 330 and 331 continues until first controller 330 determines that the last stage of rule processing has been completed. For instance, this can be accomplished by the next stage number being equal to a value assigned to the last stage or a special, particular value (e.g., value “15”).

Although not shown, padding 371 is stored within a storage element for later retrieval in order to remove padding when returning the data set back to normal format. This normally is performed in response to a STORE instruction being executed by the processor.

According to another embodiment of the invention, it is contemplated that a single controller may be implemented to perform the same operations as first and second controllers 330 and 331. Also, as yet another embodiment of the invention, second controller 331 may be separate from Rule Engine 300 as illustrated by dashed lines 390. Thus, in lieu of generating a normalized layout by applying the padding at the Rule Engine 300, it is contemplated that the data and padding 371 may be supplied from the Rule Engine 300 for subsequent use by other logic prior to loading into processor storage element(s) 380.

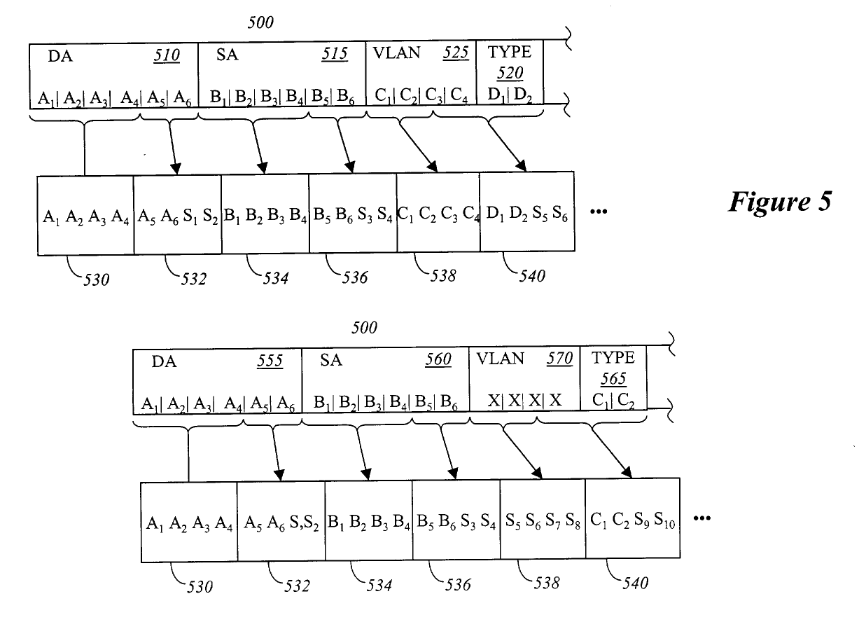

Referring now to FIG. 5, an illustrative embodiment of the operations of the Rule Engine of FIG. 3 is shown. For this embodiment, the Rule Engine is configured to provide a common layout for loading 4-byte processor storage elements independent of whether a Media Access Control (MAC) header features a VLAN ID. Of course, this embodiment is merely illustrative to understand the operations of the Rule Engine and should not be construed in any limiting fashion.

As shown, a first MAC header 500 includes at least a destination address (DA) field 510, a source address (SA) field 515, a Type field 520 and an active VLAN ID field 525. The second MAC header 550 includes DA field 555, SA field 560, a Type field 565 and an inactive VLAN ID field 570. For these MAC headers 500 and 550, the DA fields 510,555 and SA fields 515,560 are each configured to be six-bytes in length. The Type fields 520,565 are configured to be two-bytes in length and the VLAN ID fields 525,570 are configured to be four-bytes in length. Herein, the use of padding enables a common format.

With respect to the MAC header 500, a first four-bytes of destination address (A1-A4) are loaded into a first processor register 530. The next two-bytes of destination address (A5,A6) are loaded into a second processor register 532 along with two bytes of padding (S1,S2). Similarly, the first four-bytes of source address (B1-B4) are loaded into a third processor register 534. The next two-bytes of destination address (B5,B6) are loaded into a fourth processor register 536 along with two bytes of padding (S3,S4).

Thereafter, four-bytes (C1-C4) associated with the VLAN ID are loaded into a fifth processor register 538. Two-bytes (D1,D2) associated with the Type field 520 are loaded into a sixth processor register 540 along with two bytes of padding (S5,S6), filling register 540.

Likewise, in the event that the MAC header 550 is associated with the data set, a first four-bytes of destination address (A1-A4) are loaded into first processor register 530. The next two-bytes of destination address (A5,A6) are loaded into second processor register 532 along with two bytes of padding (S1,S2). Similarly, the first four-bytes of source address (B1-B4) are loaded into third processor register 534 while the next two-bytes of destination address (B5,B6) are loaded into fourth processor register 536 along with two bytes of padding (S3,S4).

Since the VLAN ID is not provided with the MAC header 550, four-bytes of padding (S5-S8) are loaded into fifth processor register 538. Then, two-bytes (C1,C2) associated with the Type field 580 are loaded into sixth processor register 540 with two bytes of padding (S9,S10) filling the register 540.

As a result, the layout of the processor registers 530, 532, 534, 536, 538, 540 is uniform and equivalent to one another, irregardless on whether or not the VLAN ID is utilized.

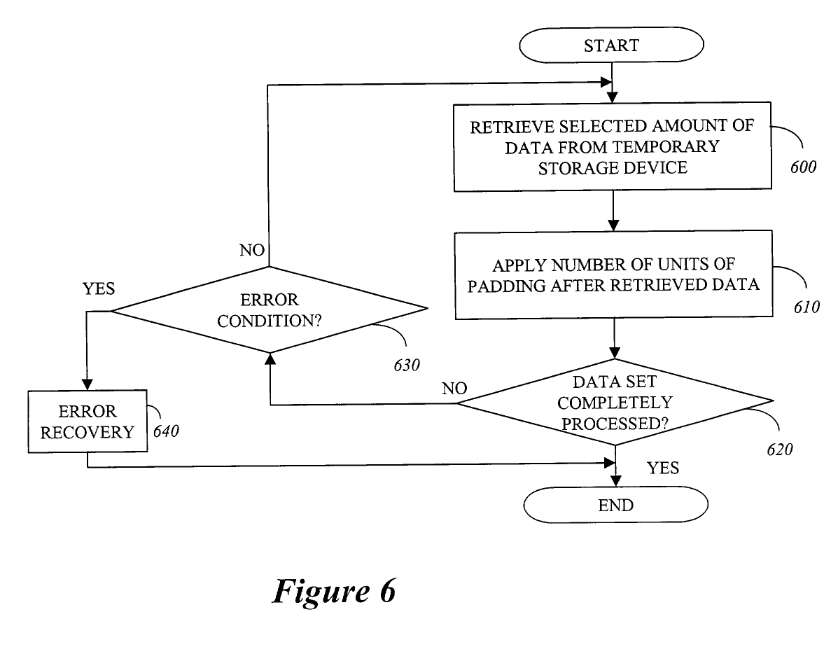

Referring to FIG. 6, an illustrative embodiment of a flowchart describing padding operations of the Rule Engine is shown. These padding operations are generally iterative in nature.

Initially, the Rule Engine initially retrieves a selected amount of streaming data (block 600). The amount of data retrieved is based on a programmable value stored in volatile or non-volatile memory local to and accessible by the Rule Engine. The streaming data may be retrieved from a temporary storage device.

Next, where applicable, the Rule Engine applies a number of units (e.g., bits, bytes, etc.) of blank space after the retrieved data is loaded into the processor storage element(s) as shown in block 610. The number of units is based on another value stored in volatile or non-volatile memory local to and accessible by the Rule Engine.

Thereafter, a determination is then made whether the data set has been completely processed (block 620). If the data set has not been completely processed, additional data is retrieved and padding may be applied as needed as set forth in block 610 and 620. If the data set can not been completely processed due to error conditions, data processing may be stalled and any variety of error recovery mechanisms may be utilized (blocks 630 and 640).

Using FIG. 5 as an illustrative example, the Rule Engine initially determines the context of the data set to be a MAC frame featuring a MAC header having a DA field of 6-bytes, a SA field of 6-bytes, a Type field of 2-bytes, a VLAN ID of 4-bytes and the like. Thus, the Rule Engine initially retrieves 6 bytes of data from a temporary storage device that receives the MAC frame as streaming data. The 6 bytes of data are loaded into the processor storage element(s) along with 2 bytes of blank space.

The next amount of data retrieved is determined by the Rule Engine to be 6 bytes of data associated with the source address. These 6 bytes of data are loaded into the processor storage element(s) along with 2 bytes of blank space.

Next, if the VLAN ID is present, the Rule Engine retrieves 4-bytes of data associated with the VLAN ID and loads this data into the processor storage element(s). Otherwise, 4-bytes of blank space are loaded into the processor storage elements(s).

Next, the Rule Engine retrieves 2-bytes of data and loads this data along with 2 bytes of blank space into the processor storage element(s). As a result, the padding information is locally stored as 6,2;6,2;4,0;2,2 for MAC frames having VLAN IDs and 6,2;6,2;0,4;2,2 for MAC frames not having VLAN IDs.

While the invention has been described in terms of several embodiments, the invention should not limited to only those embodiments described, but can be practiced with modification and alteration within the spirit and scope of the appended claims. The description is thus to be regarded as illustrative instead of limiting.

What is claimed is:

1. A processor comprising:
a plurality of storage elements; and
a rule engine coupled to the plurality of storage elements, the rule engine to create a substantially uniform layout for data embodied in a data set being loaded into the plurality of storage elements, the layout being shared by at least three different types of data sets.

2. The processor of claim 1, wherein the data set is a media access control (MAC) frame.

3. The processor of claim 1, wherein the rule engine inserts padding information before or after selected bytes of the data in order to creates the substantially uniform layout.

4. The processor of claim 1, wherein the rule engine comprises:
a content addressable memory (CAM);
a random access memory (RAM); and
a first controller in communication with the RAM.

5. The processor of claim 4, wherein the CAM is configured to contain a plurality of stages, each stage associated with a plurality of processing rules used for comparison of data accessed from the data set and pre-loaded master data and an index to be output if the master data matches the data accessed from the data set.

6. The processor of claim 5, wherein the RAM includes a plurality of memory entries each including a unique index and state information, at least a portion of the state information being output to the first controller when the index supplied by the CAM matches the unique index stored in the RAM.

7. The processor of claim 6, wherein the portion of the state information including padding for creation of the substantially uniform layout.

8. The processor of claim 7, wherein the state information further includes a next stage value for selection of a next grouping of processing rules associated with a stage and next stage size for accessing a selected amount of data from the data set.

9. The processor of claim 1, wherein the plurality of storage elements are on-chip processor registers.

10. A rule engine comprising:
a content addressable memory (CAM) to compare at least a portion of data associated with an incoming data set with pre-loaded master data, the CAM to output an index based on a result of a comparison between the portion of the data and the pre-loaded master data;
a random access memory (RAM) coupled to the CAM, the RAM to output state information based on a value of the index received from the CAM; and
at least one controller coupled to the RAM and the CAM, the at least one controller to create a substantially uniform layout, shared by the incoming data set and at least one type of data set differing from the incoming data set, for loading of the data associated with the incoming data set into processor storage elements.

11. The rule engine of claim 10 further comprising:
a buffer to receive and temporarily store the incoming data set.

12. The rule engine of claim 11, wherein the state information includes padding provided to the at least one controller for creation of the uniform layout.

13. The rule engine of claim 12, wherein the state information further includes context information utilized for creation of the uniform layout.

14. The rule engine of claim 13, wherein the state information further includes a next stage value and a next stage size supplied to the at least one controller, the next stage value being used for selection of a next grouping of processing rules and the next stage size being used to access a next selected amount of data of the data set from the buffer.

15. A method comprising:
retrieving data from an incoming data set;
applying padding information to the retrieved data in accordance with a layout shared by the incoming data set and at least two types of data sets differing from the incoming data set; and
directly loading the padded data in accordance with the layout into processor storage elements.

16. The method of claim 15, wherein an amount of bits of the padding information applied is programmable.

17. The method of claim 15, wherein the padding includes blank spaces represented by a NULL value.

18. The method of claim 15, wherein prior to applying the padding information, the method further comprises:
supplying the padding information and context information to a first controller, the controller applying the padding information to produce the layout.

19. The method of claim 18 further comprising:
supplying a next stage size to a second controller, the next stage size being used to retrieve a next selected amount of data associated with the data set.
